(19) United States
(12) Patent Application Publication
(10) Pub. No.: US 2008/0294604 A1
(43) Pub. Date: Nov. 27, 2008

(54) XQUERY JOIN PREDICATE SELECTIVITY ESTIMATION

(75) Inventor: Sauraj GOSWAMI, Palo Alto, CA (US)

Correspondence Address: IBM ST-SVL;SAWYER LAW GROUP LLP, 2465 E. Bayshore Road, Suite No. 406, PALO ALTO, CA, 94303, US

(73) Assignee: International Business Machines, Armonk, NY (US)

(21) Appl. No.: 11/754,193

(22) Filed: May 25, 2007

(51) Int. Cl. G06F 17/30

(52) U.S. Cl. 707/3; 707/E17.129

(57) ABSTRACT

A method for estimating a selectivity of a join predicate in an XQuery expression is provided. The method provides for determining a first sequence size of a first sequence in the join predicate, determining a second sequence size of a second sequence in the join predicate, determining a type of comparison operator used between the first sequence and the second sequence, estimating the selectivity of the join predicate based on the first sequence size, the second sequence size, and the type of comparison operator used, selecting an execution plan for the XQuery expression based on the selectivity of the join predicate estimated, and executing the XQuery expression using the execution plan selected.

### FIELD OF THE INVENTION

The present invention relates generally to selectivity estimation of XQuery join predicates.

### BACKGROUND OF THE INVENTION

XQuery (XML Query) is a computer language designed to query (e.g., retrieve) XML (eXtensible Markup Language) data. XQuery is comparable to SQL (Structured Query Language), which is designed to query relational data (e.g., tables). XQuery and SQL expressions sometimes include one or more join predicates. In order to select an efficient execution plan for an XQuery expression or a SQL expression that includes a join predicate, the selectivity of the join predicate will need to be estimated.

Estimating selectivity of a join predicate in an XQuery expression differs from estimating selectivity of a join predicate in a SQL expression because with XQuery, the comparison is typically between sequences (e.g., paths), whereas with SQL, the comparison is usually between individual elements (e.g., table cells). Join selectivity estimation involving sequences can vary depending on the size of the sequences. As a result, existing SQL join selectivity estimation formulas, which have no concept of sequence size, cannot be used for XQuery join selectivity estimation.

### SUMMARY OF THE INVENTION

A method for estimating a selectivity of a join predicate in an XQuery expression is provided. The method provides for determining a first sequence size of a first sequence in the join predicate of the XQuery expression, the first sequence size corresponding to a number of elements included in the first sequence, determining a second sequence size of a second sequence in the join predicate of the XQuery expression, the second sequence size corresponding to a number of elements included in the second sequence, determining a type of comparison operator used between the first sequence and the second sequence in the join predicate of the XQuery expression, estimating the selectivity of the join predicate in the XQuery expression based on the first sequence size, the second sequence size, and the type of comparison operator used between the first sequence and the second sequence, selecting an execution plan for the XQuery expression based on the selectivity of the join predicate that is estimated, and executing the XQuery expression using the execution plan that is selected.

In one implementation, responsive to the type of comparison operator being an equal to operator, the selectivity of the join predicate is estimated by calculating a probability of selecting a first set of one or more elements from a first domain and a second set of one or more elements from a second domain such that the first set and the second set do not intersect and subtracting from 1 the probability of selecting the first set and the second set such that the first set and the second set do not intersect that is calculated.

### BRIEF DESCRIPTION OF THE DRAWINGS

FIG. 1 depicts a process for estimating a selectivity of a join predicate in an XQuery expression according to an implementation of the invention.

FIGS. 2A-2F illustrate a process for estimating a selectivity of a join predicate in an XQuery expression according to an implementation of the invention.

FIG. 3 shows a sample domain with non-intersecting sets according to an implementation of the invention.

FIGS. 4A-4B depict sample intersecting domains according to an implementation of the invention.

FIG. 5 illustrates a sample number line that represents a domain according to an implementation of the invention.

FIG. 6 shows a sample domain that has been divided into bands according to an implementation of the invention.

FIGS. 7A-7B depict sample number lines that represent domains according to implementations of the invention.

FIG. 8 illustrates a block diagram of a data processing system with which implementations of the invention can be implemented.

### DETAILED DESCRIPTION

The present invention generally relates to selectivity estimation of XQuery join predicates. The following description is presented to enable one of ordinary skill in the art to make and use the invention and is provided in the context of a patent application and its requirements. The present invention is not intended to be limited to the implementations shown, but is to be accorded the widest scope consistent with the principles and features described herein.

XML (eXtensible Markup Language) is a versatile markup language that is capable of labeling information from diverse data sources. XQuery (XML Query) is a computer language that provides a flexible way to query (e.g., retrieve, manipulate, etc.) XML data. The use of XQuery on XML data is analogous to the use of SQL (Structured Query Language) on relational data (e.g., data stored in tables). SQL is a computer language that can be used to query relational data.

An expression in XQuery or SQL may specify one or more predicates, which are conditions used to filter the data being queried. For example, a user querying a table containing employee records may only want to obtain the records for employees in a particular department. Typically, in both XQuery and SQL, a predicate follows a WHERE clause. Predicates may also be embedded in XPath expressions. XPath is a computer language used to identify and locate nodes in an XML document.

Join predicates are a special type of predicate that joins (e.g., merges, combines, and the like) data from, for instance, multiple tables or multiple XML documents. One or more types of comparison operators (e.g., =, >, <, ≧, ≦, etc.) are usually used in a join predicate.

Below is a sample SQL expression that includes a join predicate:
SELECT *
FROM users, personal_ads
WHERE users.user_id=personal_ads.user_id

In the sample SQL expression above, the join predicate ‘users.user_id=personal_ads.user_id’ limits the results returned from table ‘users’ and table ‘personal_ads’ to those users that have placed personal ads. Various execution plans can be generated for the sample SQL expression above. In order to select the most efficient execution plan, selectivity of the join predicate in the SQL expression will need to be estimated. Selectivity estimation relates to the probability that the join predicate will evaluate to TRUE given the underlying data (e.g., ‘users’ table and ‘personal_ads’ table).

Below is a sample XQuery expression that includes a join predicate:
FOR $i IN doc(“storeA.xml”)/department/toys
   $j IN doc(“storeB.xml”)/department/toys
WHERE $i/product_name=$j/product_name
RETURN <diff> $i/price−$j/price </diff>

In the sample XQuery expression above, variable ‘$i’ is bound to path ‘/department/toys’ in the ‘storeA’ XML document and variable ‘$j’ is bound to path ‘/department/toys’ in the ‘storeB’ XML document. The join predicate ‘$i/product_name=$j/product_name’ in the sample XQuery expression is used to search for toy products that are sold by both stores. For each toy product sold by both stores, the price difference between the two stores are calculated and returned as a result. Similar to the sample SQL expression above, different execution plans can be generated for the sample XQuery expression. Hence, in order to select the most efficient execution plan, selectivity of the join predicate in the XQuery expression will also need to be estimated.

Many formulas have been devised to estimate selectivity of SQL joins. However, existing SQL join selectivity estimation formulas cannot be used to estimate selectivity of XQuery joins because XQuery joins typically involve comparisons between sequences or sets of elements rather than comparisons between individual elements as in SQL joins. For instance, in the sample SQL expression above, the comparison is between one user ID and another user ID. In contrast, in the sample XQuery expression above, the comparison is between one sequence of product names and another sequence of product names, where each sequence may include multiple product names.

With sequences, the selectivity estimation will change when the size of a sequence (e.g., number of elements in the sequence) changes. For example, if the size of the sequence is so big that it is close to a total number of possible distinct elements, then join selectivity is expected to be close to 1 because a sequence that big is likely to have something in common with whatever it is joined with. Similarly, if the size of the sequence is small relative to the total number of possible distinct elements, then join selectivity is expected to be much less. Hence, formulas used to estimate selectivity of SQL joins are not applicable to selectivity estimation of XQuery joins because sequence size is not a consideration in those formulas as the notion of sequences does not exist in SQL.

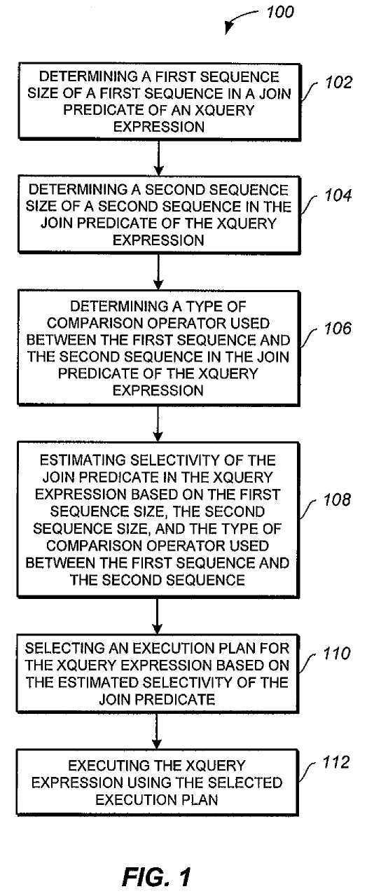

Depicted in FIG. 1 is a process 100 for estimating a selectivity of a join predicate in an XQuery expression according to an implementation of the invention. At 102, a first sequence size of a first sequence in the join predicate of the XQuery expression is determined. In one implementation, the first sequence size corresponds to a number of elements included in the first sequence. At 104, a second sequence size of a second sequence in the join predicate of the XQuery expression is determined. In one implementation, the second sequence size corresponds to a number of elements included in the second sequence. Sequence sizes may be determined from statistics that have been collected.

At 106, a type of comparison operator used between the first sequence and the second sequence in the join predicate of the XQuery expression is determined. At 108, the selectivity of the join predicate in the XQuery expression is estimated based on the first sequence size, the second sequence size, and the type of comparison operator used between the first sequence and the second sequence.

At 110, an execution plan is selected for the XQuery expression based on the selectivity of the join predicate that is estimated. At 112, the XQuery expression is executed using the execution plan that is selected. Process 100 may include additional process blocks (not shown), such as, displaying results from execution of the XQuery expression to a user.

By taking into account the sequence sizes of sequences involved in a join predicate of an XQuery expression and the comparison operator used between the sequences, selectivity of the join predicate can be more accurately estimated. In addition, selectivity estimation based on sequence size and comparison operator does not require elaborate distribution or correlation statistics to be collected. As a result, costs associated with estimating selectivity based on sequence size and comparison operator should be less than other methods.

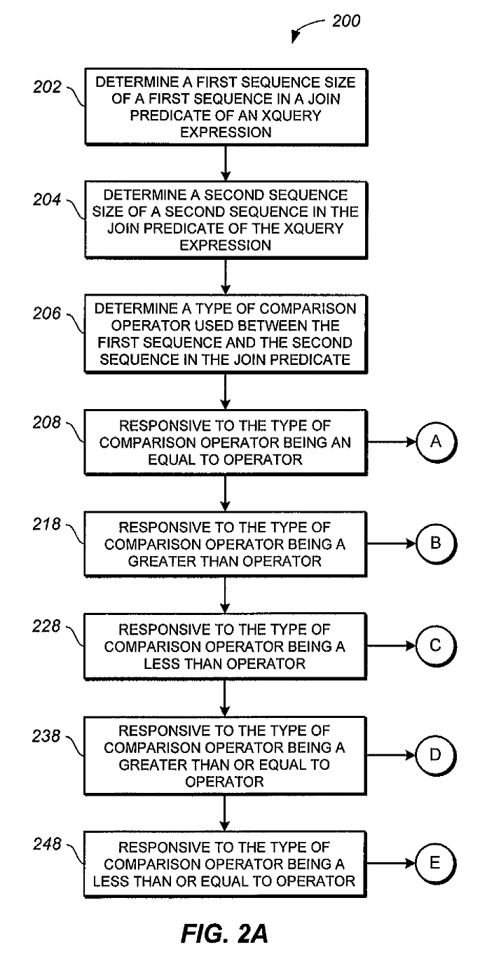

FIGS. 2A-2F illustrate a process 200 for estimating a selectivity of a join predicate in an XQuery expression according to an implementation of the invention. At 202, a first sequence size of a first sequence in the join predicate of the XQuery expression is determined. The first sequence size corresponds to a number of elements included in the first sequence. In one implementation, the first sequence includes one or more elements produced by a first path identifier of a first XML document. A path identifier of an XML document identifies a set of one or more nodes within the XML document.

At 204, a second sequence size of a second sequence in the join predicate of the XQuery expression is determined. The second sequence size corresponds to a number of elements included in the second sequence. In one implementation, the second sequence includes one or more elements produced by a second path identifier of a second XML document. The first path identifier and/or the second path identifier may be in XPath.

In one implementation, the first sequence size and/or the second sequence size are approximations of the number of elements that can be produced by the path identifier for the corresponding sequence. For instance, the first sequence size may be an average number of elements produced by a path identifier of an XML document as the number of elements produced may change as the XML document changes.

At 206, a type of comparison operator used between the first sequence and the second sequence in the join predicate of the XQuery expression is determined. There are many types of comparison operators, such as an equal to operator (‘=’), a greater than operator (‘>’), a less than operator (‘<’), a greater than or equal to operator (‘≧’), a less than or equal to operator (‘≦’), and so forth.

At 208, responsive to the type of comparison operator being an equal to operator, process 200 proceeds to 210 in FIG. 2B. At 210, a probability of selecting a first set of one or more elements from a first domain and a second set of one or more elements from a second domain such that the first set and the second set do not intersect (e.g., the first set and the second set are non-intersecting sets) is calculated. In the implementation, a number of elements to be selected for the first set is equal to the first sequence size and a number of elements to be selected for the second set is equal to the second sequence size. The first set and the second set do not intersect when none of the elements in the first set is found in the second set and none of the elements in the second set is found in the first set.

At 212, the calculated probability of selecting the first set and the second set such that the first set and the second set do not intersect is subtracted from 1 to obtain an estimated selectivity of the join predicate. At 214, an execution plan for the XQuery expression is selected based on the estimated selectivity of the join predicate. At 216, the XQuery expression is executed using the selected execution plan.

In the implementation, the probability that the first sequence is equal to the second sequence is determined by calculating the probability of selecting the first set and the second set such that the first set and the second set intersect (i.e., at least one element in the first set is also found in the second set). However, rather than directly calculating the probability of selecting the first set and the second set such that the first set and the second set intersect, it is easier to calculate its complement (i.e., the probability of selecting the first set and the second set such that the first set and the second set do not intersect) and subtract the complement from 1.

Referring back to FIG. 2A, at 218, responsive to the type of comparison operator being a greater than operator, process 200 proceeds to 220 in FIG. 2C. At 220, a probability of selecting a first set of one or more elements from a first domain and a second set of one or more elements from a second domain such that all elements in the first set are less than or equal to a minimum element in the second set is calculated. In the implementation, a number of elements to be selected for the first set is equal to the first sequence size and a number of elements to be selected for the second set is equal to the second sequence size.

At 222, the calculated probability of selecting the first set and the second set such that all elements in the first set are less than or equal to the minimum element in the second set is subtracted from 1 to obtain an estimated selectivity of the join predicate. As with the equal to operator, it is easier to calculate the complement probability and then subtract it from 1 to obtain the estimated selectivity of the join predicate. At 224, an execution plan for the XQuery expression is selected based on the estimated selectivity of the join predicate. At 226, the XQuery expression is executed using the selected execution plan.

Referring back to FIG. 2A, at 228, responsive to the type of comparison operator being a less than operator, process 200 proceeds to 230 in FIG. 2D. At 230, a probability of selecting a first set of one or more elements from a first domain and a second set of one or more elements from a second domain such that all elements in the second set are less than or equal to a minimum element in the first set is calculated. In the implementation, a number of elements to be selected for the first set is equal to the first sequence size and a number of elements to be selected for the second set is equal to the second sequence size.

At 232, the calculated probability of selecting the first set and the second set such that all elements in the second set are less than or equal to a minimum element in the first set is subtracted from 1 to obtain an estimated selectivity of the join predicate. At 234, an execution plan for the XQuery expression is selected based on the estimated selectivity of the join predicate. At 236, the XQuery expression is executed using the selected execution plan.

Referring back to FIG. 2A, at 238, responsive to the type of comparison operator being a greater than or equal to operator, process 200 proceeds to 240 in FIG. 2E. At 240, a probability of selecting a first set of one or more elements from a first domain and a second set of one or more elements from a second domain such that all elements in the first set are less than a minimum element in the second set is calculated. In the implementation, a number of elements to be selected for the first set is equal to the first sequence size and a number of elements to be selected for the second set is equal to the second sequence size.

At 242, the calculated probability of selecting the first set and the second set such that all elements in the first set are less than a minimum element in the second set is subtracted from 1 to obtain an estimated selectivity of the join predicate. At 244, an execution plan for the XQuery expression is selected based on the estimated selectivity of the join predicate. At 246, the XQuery expression is executed using the selected execution plan.

Referring back to FIG. 2A, at 248, responsive to the type of comparison operator being a less than or equal to operator, process 200 proceeds to 250 in FIG. 2F. At 250, a probability of selecting a first set of one or more elements from a first domain and a second set of one or more elements from a second domain such that all elements in the second set are less than a minimum element in the first set is calculated. In the implementation, a number of elements to be selected for the first set is equal to the first sequence size and a number of elements to be selected for the second set is equal to the second sequence size.

At 252, the calculated probability of selecting the first set and the second set such that all elements in the second set are less than a minimum element in the first set is subtracted from 1 to obtain an estimated selectivity of the join predicate. At 254, an execution plan for the XQuery expression is selected based on the estimated selectivity of the join predicate. At 256, the XQuery expression is executed using the selected execution plan.

Probability that First Set and Second Set Do Not Intersect

In one implementation, calculating the probability of selecting a first set from a first domain and a second set from a second domain such that the first set and the second set do not intersect comprises assuming there are no duplicate elements in either the first set or the second set, assuming one of the first domain and the second domain is a superset of the other domain (i.e., one of the domains is a subset of the other domain, which is also referred to as domain subset assumption), and determining a number of distinct elements in the one domain.

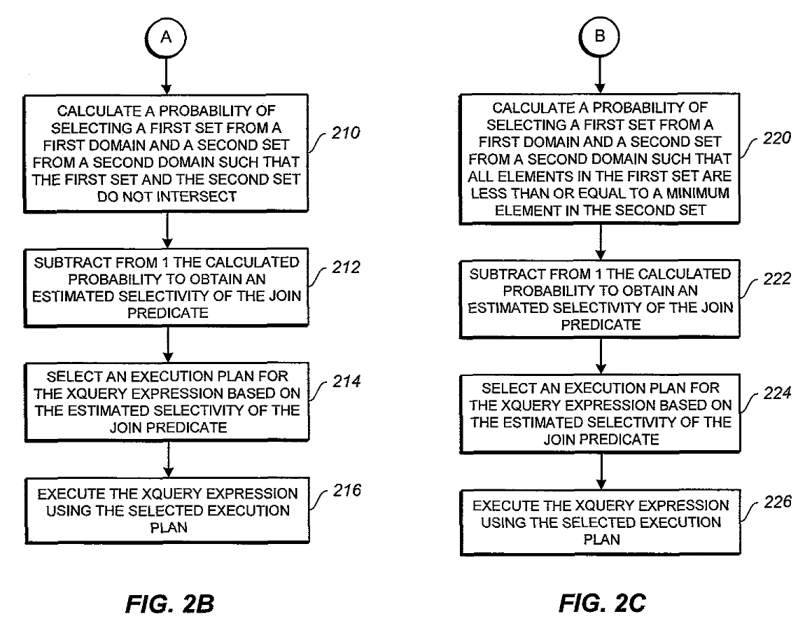

Based on the above assumptions and determination, let N represent the number of distinct elements in the one domain, let k₁ represent a number of elements to be selected for the first set, and let k₂ represent a number of elements to be selected for the second set. Shown in FIG. 3 is a sample domain 300 in which non-intersecting sets 302 and 304 have been selected according to an implementation of the invention. The total number of ways to select the first set of k₁ elements and the second set of k₂ elements from the one domain with N distinct elements is:

(^{N}Cₖ_{₁})×(^{N}Cₖ_{₂}) (1)

where (^{N}Cₖ) is the binomial coefficient corresponding to the formula:

$$\frac{N !}{k ! \times ( N - k ) !} ,$$

which is the number of ways of choosing a set of size k from a larger set of size N.

In order for the first set and the second set to be non-intersecting sets, once the first set of k₁ elements has been selected, the second set of k₂ elements will have to be selected from the remainder of the one domain, which is N−k₁. Thus, the total number of ways of picking non-intersecting sets from the one domain with N distinct elements is:

(^{N}Cₖ_{₁})×(^{N-k}^{₁}Cₖ_{₂}) (2)

Accordingly, the probability of selecting the first set and the second set such that the first set and the second set do not intersect can be computed by dividing Equation (2) by Equation (1):

$$\frac{{(}^{N} {C}_{{k}_{1}} ) \times ( {}_{}^{N - {k}_{1}}{C}{}_{{k}_{2}}^{} )}{{(}^{N} {C}_{{k}_{1}} ) \times ( {}_{}^{N}{C}{}_{{k}_{2}}^{} )} = \frac{( {}_{}^{N - {k}_{1}}{C}{}_{{k}_{2}}^{} )}{( {}_{}^{N}{C}{}_{{k}_{2}}^{} )} \qquad ( 3 )$$

In another implementation, calculating the probability of selecting a first set from a first domain and a second set from a second domain such that the first set and the second set do not intersect comprises assuming one of the first domain and the second domain is a superset of the other domain and determining a number of distinct elements in the one domain.

Unlike the above implementation, the first set and the second set are not assumed to be without duplicate values in this implementation. Hence, in this implementation, the probability calculation takes into consideration instances where duplicates are included in one or both of the sets. The equation for choosing k elements, with duplicates, from a domain with N distinct elements is:

(^{N+k-1}Cₖ) (4)

Based on the above assumptions and determination, let N represent the number of distinct elements in the one domain, let k₁ represent a number of elements to be selected for the first set, let k₂ represent a number of elements to be selected for the second set, and let m represent a number of distinct elements from which the first set of k₁ elements is to be selected. Then the number of ways of choosing the first set of k₁ elements, with duplicates, from m distinct elements is:

(^{m+k}^{₁}⁻¹Cₖ_{₁}) (5)

There are, of course

(^{N}Cₘ) (6)

ways of choosing m distinct elements from the one domain with N distinct elements. Therefore, the total number of ways of choosing the first set of k₁ elements, with possible duplicates, from m distinct elements that are selected from the one domain with N distinct elements is:

(^{N}Cₘ)×(^{m+k}^{₁}⁻¹Cₖ_{₁}) (7)

From above, it appears that summing up Equation (7) for m ranging from 1 to k₁ will result in the total number of ways of selecting the first set of k₁ elements and that for each selection, the non-intersecting second set can be selected as before, i.e., by restricting to N−m elements. This, however, will be incorrect as the same non-intersecting sets will be counted multiple times. For instance, let N be 100, m be 5, and k₁ be 10. If m is the first 5 elements of N, then one of the possible selections of the first set will only include the first 2 elements in N. However, this selection can also appear if m is the first 8 elements of N. As a result, the same set can be produced by Equation (7) when m is 5, when m is 8, and when m is some other number.

The way around the above problem is to make sure that selections of different sets of k₁ elements are unique. One way to do so is to ensure that when k₁ elements are selected from m, each of the m elements is selected at least once. Hence, if k₁ is 10 and m is 4, then only 6 (10−4) of the 10 elements can be selected with replacement from m. In this case, the only way to get a k₁ set that is made up of the first two elements is when m is 2 and the first two elements are selected. This is unlike the previous strategy where the same set of k₁ elements is encountered multiple times.

With the revised strategy, the total number of ways to select the first set of k₁ elements from m distinct elements, which are selected from the one domain of N distinct elements is:

(^{N}Cₘ)×(^{m+k}^{₁}^{-m-1}Cₖ_{₁}₋ₘ) (8)

The first term in Equation (8) represents the number of ways of choosing m distinct elements from the one domain of N distinct elements. The second term in Equation (8) represents the number of ways of selecting a set of k₁ elements from m distinct elements such that there is at least one of each of the m elements in the set, which is the same as choosing k₁−m elements with replacement from m. Equation (8) can be simplified and rewritten as:

(^{N}Cₘ)×(^{k}^{₁}⁻¹Cₖ_{₁}₋ₘ) (9)

For each set of k₁ elements selected, a non-intersecting set of k₂ elements can be selected from the remaining N−m elements. Thus, for a given m, the total number of ways of choosing non-intersecting sets will be:

(^{N}Cₘ)×(^{k}^{₁}⁻¹Cₖ_{₁}₋ₘ)×(^{N-m+k}^{₂}⁻¹Cₖ_{₂}) (10)

In Equation (10), m can range from 1 to k₁. Therefore, the total number of ways to select non-intersecting sets of size k₁ and k₂ are:

$${\sum }_{m = 1}^{{k}_{1}} ( {}_{}^{N}{C}{}_{m}^{} ) \times ( {}_{}^{{k}_{1} - 1}{C}{}_{{k}_{1} - m}^{} ) \times ( {}_{}^{N - m + {k}_{2} - 1}{C}{}_{{k}_{2}}^{} ) \qquad ( 11 )$$

Therefore, the probability of selecting the first set and the second set such that the first set and the second set do not intersect can be calculated using the following equation:

$$\frac{{\sum }_{m = 1}^{{k}_{1}} ( {}_{}^{N}{C}{}_{m}^{} ) \times ( {}_{}^{{k}_{1} - 1}{C}{}_{{k}_{1} - m}^{} ) \times ( {}_{}^{N - m + {k}_{2} - 1}{C}{}_{{k}_{2}}^{} )}{( {}_{}^{N + {k}_{1} - 1}{C}{}_{{k}_{1}}^{} ) \times ( {}_{}^{N + {k}_{2} - 1}{C}{}_{{k}_{2}}^{} )} \qquad ( 12 )$$

Equation (12) was derived by choosing sets with k₁ elements in a particular way. The same analysis is applicable when the focus is on selecting sets with k₂ elements. In that case, the probability of selecting non-intersecting sets can be calculated using the following equation:

$$\frac{{\sum }_{m = 1}^{{k}_{2}} ( {}_{}^{N}{C}{}_{m}^{} ) \times ( {}_{}^{{k}_{2} - 1}{C}{}_{{k}_{2} - m}^{} ) \times ( {}_{}^{N - m + {k}_{1} - 1}{C}{}_{{k}_{1}}^{} )}{( {}_{}^{N + {k}_{1} - 1}{C}{}_{{k}_{1}}^{} ) \times ( {}_{}^{N + {k}_{2} - 1}{C}{}_{{k}_{2}}^{} )} \qquad ( 13 )$$

Therefore, either Equation (12) or Equation (13) can be used to compute join selectivity. Equation (12) will be easier to compute if k₁ is a smaller value. Conversely, Equation (13) will be easier to compute if k₂ is a smaller value.

Calculating the probability of selecting a first set and a second set such that the first set and the second set do not intersect using Equation (3) is much more inexpensive than using, for instance, Equations (12) or (13). Therefore, Equation (3) should be used whenever reasonable. Equation (3) provides a reasonable approximation to Equations (12) and (13) when both k₁ and k₂ are small compared to N.

In one implementation, Equation (3) is used if both of the following ratios are close to 1:

$$\begin{matrix}\frac{( {}_{}^{N}{C}{}_{{k}_{1}}^{} )}{( {}_{}^{N + {k}_{1} - 1}{C}{}_{{k}_{1}}^{} )} & ( 14 ) \\ \frac{( {}_{}^{N}{C}{}_{{k}_{2}}^{} )}{( {}_{}^{N + {k}_{2} - 1}{C}{}_{{k}_{2}}^{} )} & ( 15 )\end{matrix}$$

Equations (14) and (15) measure the number of sets of size k₁ and the number of sets of size k₂ that can be selected from a universe of N elements without replacement (e.g., assume there are no duplicate elements in either set) as opposed to with replacement (e.g., leaves open the possibility of having duplicate elements in one or both sets).

In a further implementation, calculating the probability of selecting a first set from a first domain and a second set from a second domain such that the first set and the second set do not intersect comprises assuming there are no duplicate elements in either the first set or the second set, assuming the first domain intersects with the second domain, determining a number of distinct elements in the first domain, and determining a number of distinct elements in the second domain.

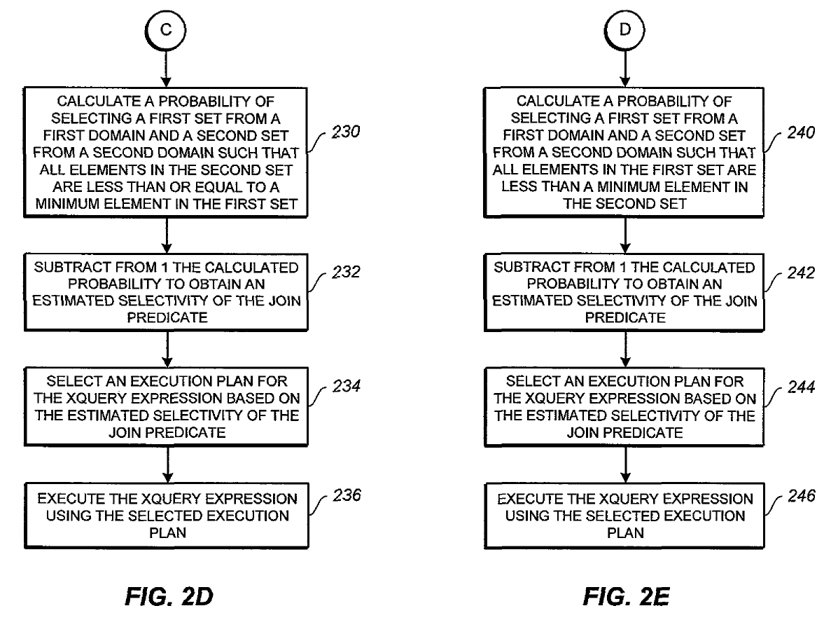

FIGS. 4A-4B depict sample intersecting domains 402 and 404 according to an implementation of the invention. Two non-intersecting sets, a first set 406 and a second set 408, have been selected at random from domains 402 and 404, respectively. For purposes of notation, let N₁ represent the number of distinct elements in domain 402, let N₂ represents the number of distinct elements in domain 404, let k₁ represents the number of elements selected for the first set 406, and let k₂ represents the number of elements selected for the second set 408.

In addition, let N₁/N₂ represent the number of distinct elements in domain 402 that are not in the intersection of domains 402 and 404, which is depicted in FIG. 4B as a dotted area 410. Let N₁N₂ represent the number of distinct elements in the intersection of domains 402 and 404, which is depicted in FIG. 4B as a stripped area 412. Let N₂/N₁ represent the number of distinct elements in domain 404 that are not in the intersection of domains 402 and 404, which is depicted in FIG. 4B as a cross-hashed area 414.

To calculate the number of ways the first set 406 can be selected from the domain 402, suppose m elements of the first set 406 are selected from N₁/N₂, which is dotted area 410, and n elements of the first set 406 are selected from N₁N₂, which is stripped area 412. In other words, k₁=m+n elements. Therefore, n=k₁−m, and the total number of ways that the first set 406 can be selected from the domain 402 is:

(^{N}^{₁}^{/N}^{₂}Cₘ)×(^{N}^{₁}^{N}^{₂}Cₖ_{₁}₋ₘ) (16)

The first term in Equation (4) represents the number of ways that m elements of the first set 406 can be selected from N₁/N₂, which is dotted area 410. The second term in Equation (16) represents the number of ways that n elements of the first set 406 can be selected from N₁N₂, which is stripped area 412.

The only way that the second set 408 will not intersect with the first set 406 is if all k₂ elements of the second set 408 are chosen from N₂−n elements. That is, if the choices are restricted to elements that are not part of the first set 406 in the intersection of domains 402 and 404, which is represented by stripped area 412. Hence, the number of ways that m elements of the first set 406 can be selected from N₁/N₂, which is dotted area 410, and n elements of the first set 406 can be selected from N₁N₂, which is stripped area 412, without intersecting the second set 408 is:

(^{N}^{₁}^{/N}^{₂}Cₘ)×(^{N}^{₁}^{N}^{₂}Cₖ_{₁}₋ₘ)×(^{N}^{₂}^{-(k}^{₁}^{-m)}Cₖ_{₂}) (17)

The last term in Equation (17) represents the number of ways the second set 408 can be chosen without intersecting with the first set 406. The first two terms in Equation (17) represent the number of ways of selecting the first set 406. However, m can vary between 0 and k₁ as the first set 406 could be completely in the intersecting area N₁N₂, which is stripped area 412 (meaning m=0), or the first set 406 could be completely inside non-intersecting area N₁/N₂, which is dotted area 410 (meaning m=k₁), or it could in any position between as depicted in FIGS. 4A-4B. Therefore, the total number of ways to pick the first set 406 from domain 402 and the second set 408 from domain 404 such that they do not intersect is:

$${\sum }_{m = 0}^{{k}_{1}} ( {}_{}^{{N}_{1} / {N}_{2}}{C}{}_{m}^{} ) \times ( {}_{}^{{N}_{1} {N}_{2}}{C}{}_{{k}_{1} - m}^{} ) \times ( {}_{}^{{N}_{2} - ( {k}_{1} - m )}{C}{}_{{k}_{2}}^{} ) \qquad ( 18 )$$

Accordingly, the probability of selecting the first set and the second such that the first set and the second set do not intersect is:

$$\frac{{\sum }_{m = 0}^{{k}_{1}} ( {}_{}^{{N}_{1} / {N}_{2}}{C}{}_{m}^{} ) \times ( {}_{}^{{N}_{1} {N}_{2}}{C}{}_{{k}_{1} - m}^{} ) \times ( {}_{}^{{N}_{2} - ( {k}_{1} - m )}{C}{}_{{k}_{2}}^{} )}{( {}_{}^{{N}_{1}}{C}{}_{{k}_{1}}^{} ) \times ( {}_{}^{{N}_{2}}{C}{}_{{k}_{2}}^{} )} \qquad ( 19 )$$

The denominator in Equation (19) represents the total number of ways of choosing a set of with k₁ elements from a domain with N₁ distinct elements and a set of k₂ elements from a domain with N₂ distinct elements.

Probability that All Elements in First Set ≦ Minimum Element in Second Set

In one implementation, calculating the probability of selecting a first set from a first domain and a second set from a second domain such that all elements in the first set are less than or equal to a minimum element in the second set comprises assuming there are no duplicate elements in either the first set or the second set, assuming one of the first domain and the second domain is a superset of the other domain, and determining a number of distinct elements in the one domain that is a superset of the other domain.

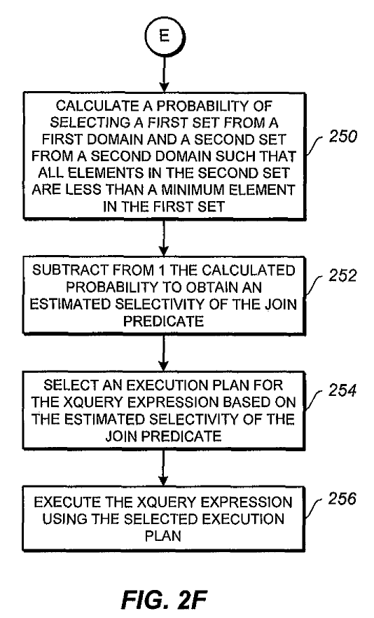

Based on the above assumptions and determinations, let N be the number of distinct elements in the one domain, let k₁ be the number of elements to be selected for the first set, and let k₂ be the number of elements to be selected for the second set. Illustrated in FIG. 5 is a sample number line 500 that represents the one domain with N distinct elements according to an implementation of the invention. Number line 500 includes a plurality of arrows. Arrow 502 represents a I^{st} element (e.g., smallest element) in the one domain. Arrow 504 represents a 2^{nd} element (e.g., a next larger element). Arrow 508 represents N^{th} element (e.g., largest element) in the one domain.

If the minimum element of the second set is m, which is represented by arrow 506, then the total number of ways of choosing the first set of k₁ elements can be obtained by restricting the selection to the range [First, m]. To simplify things, m also denotes a number of distinct elements in the range from which the first set is to be selected. The total number of possible ways to select the first set with k₁ elements, when the minimum element of the second set is m, is:

(^{m}Cₖ_{₁}) (20)

In order that all the elements of the second set, which includes k₂ elements, are greater than or equal to m, selection of the k₂ elements have to be restricted to the last N−m elements in the one domain. Since the m-th element has already been selected for the second set, there are really only k₂−1 elements that need to be selected. Therefore, the total number of possible ways to select the second set is:

(^{N-m}Cₖ_{_{2−1}}) (21)

Accordingly, for a given m, the total number of ways of choosing the first set and the second set such that all of the elements of the first set are less than or equal to the minimum element m in the second set is:

(^{m}Cₖ_{₁})×(^{N-m}Cₖ_{₂}₋₁) (22)

The product of Equation (22) will need to be added up for all possible values of m. Clearly, m cannot be less than k₁ as that will not leave enough elements to pick the first set. In addition, m cannot be greater than N−(k₂−1) as that will not leave enough elements to choose the second set. Hence, the probability of selecting the first set and the second set such that all elements in the first set are less than or equal to the minimum element in the second set is:

$$\frac{{\sum }_{m = {k}_{1}}^{N - {k}_{2} + 1} ( {}_{}^{m}{C}{}_{{k}_{1}}^{} ) \times ( {}_{}^{N - m}{C}{}_{{k}_{2} - 1}^{} )}{( {}_{}^{N}{C}{}_{{k}_{1}}^{} ) \times ( {}_{}^{N}{C}{}_{{k}_{2}}^{} )} \qquad ( 23 )$$

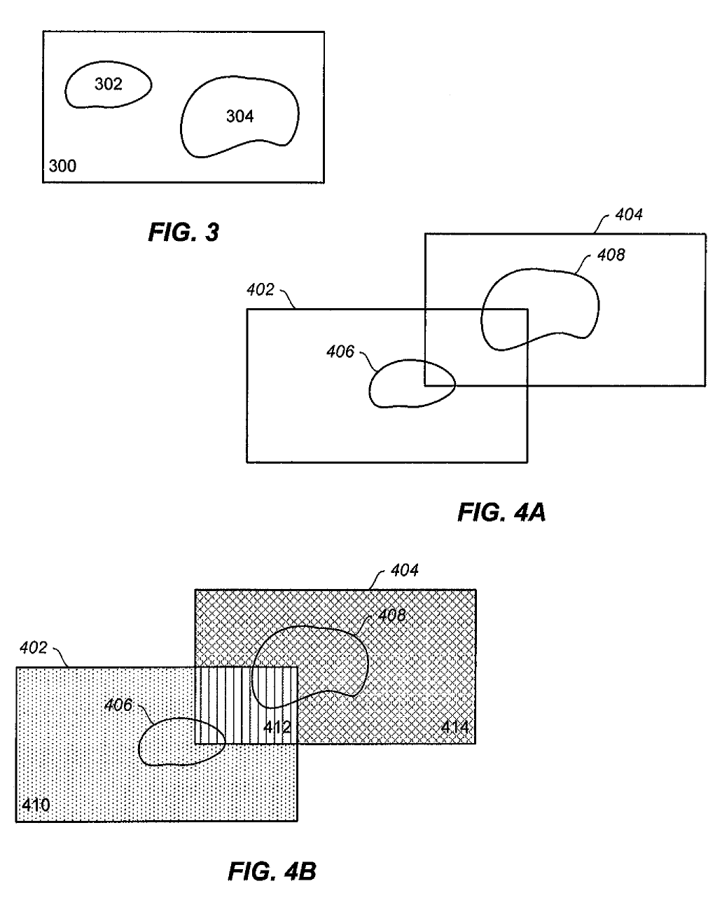

One of the issues with Equation (23) is that the number of terms could be very large and therefore computationally expensive. In order to derive a more inexpensive solution, rather than compute the product for every possible value of m, the entire range of values can be divided into a number of bands and the product can be computed for each band. FIG. 6 shows a sample domain 600 that has been divided into B bands according to an implementation of the invention. Each of the B band includes b elements.

Assume k₁ is small and assume the k₂ elements in the second set are distributed over bands 2 to B. Based on these assumptions, the first set of k₁ elements is limited to band 1 and the total number of ways of choosing the first set of k₁ elements and the second set of k₂ elements is:

(^{b}Cₖ_{₁})×(^{(B-1)×b}Cₖ_{₂}) (24)

The first term in Equation (24) represents the number of ways of selecting k₁ elements from b elements in Band 1. The second term in Equation (24) represents the number of ways of selecting k₂ elements from B−1 bands with (B−1)×b elements.

By moving from band to band, it is now possible to compute all sets where all k₁ elements of the first set are less than or equal to the k₂ elements of the second set. Moving over one band, assume that the k₂ elements in the second set are distributed over bands 3 to B and that the k₁ elements in the first set are distributed over bands 1 and 2. Given these assumptions, the total number of ways of choosing the first set of k₁ elements and the second set of k₂ elements is:

(^{2×b}Cₖ_{₁})×(^{(B-2)×b}Cₖ_{₂}) (25)

Equation (25), however, will over count some sets. For example, a set of k₁ elements in band 1 and a set of k₂ elements in band B will appear in the products of both Equation (24) and Equation (25). In order to prevent that, when moving from one band to the next, the first set of k₁ elements is required to contain one or more elements from the newly uncovered band. Hence, in the above example, when the second set of k₂ elements is restricted to bands 3 to B, at least one of the k₁ elements in the first set must come from the newly uncovered band 2. This will ensure that the sets of k₁ elements selected are unique when moving from band to band.

The sets of k₂ elements selected are not required to be unique when moving from band to band because the sets of k₁ elements selected will be unique. This implies that unique (k₁, k₂) combinations will be counted where the minimum of the k₂ elements is always greater than or equal to all of the k₁ elements.

Assume that band K is currently being processed; that is the second set of k₂ elements is being selected from bands K, K+1, up to B, and the first set of k₁ elements is being selected from bands 1 to K−1. Based on the assumption, the total number of ways of choosing the first set of k₁ elements and the second set of k₂ elements, while ensuring that one or more k₁ elements are from band K−1, is:

$$( {}_{}^{( B - K + 1 ) \times b}{C}{}_{{k}_{2}}^{} ) {\sum }_{l = 1}^{{k}_{1}} ( {}_{}^{b}{C}{}_{l}^{} ) \times ( {}_{}^{( K - 2 ) xb}{C}{}_{{k}_{1} - l}^{} ) \qquad ( 26 )$$

The term outside the summation in Equation (26) represents the number of sets of k₂ elements distributed over bands K to B. The summation represents the number of ways of choosing sets of k₁ elements distributed over bands 1 to K−1, with at least one element from band K−1 (the first term in the summation) and the rest from K−2 bands (the second term in the summation).

In order to find all such distributions, the product from Equation (26) will need to be summed up over all possible values of K. Hence, the probability of selecting the first set and the second set such that all elements in the first set are less than or equal to the minimum element in the second set is:

$$\frac{{\sum }_{K = 2}^{B} ( {}_{}^{( B - K + 1 ) \times b}{C}{}_{{k}_{2}}^{} ) {\sum }_{l = 1}^{{k}_{1}} ( {}_{}^{b}{C}{}_{l}^{} ) \times ( {}_{}^{( K - 2 ) xb}{C}{}_{{k}_{1} - l}^{} )}{( {}_{}^{N}{C}{}_{{k}_{1}}^{} ) \times ( {}_{}^{N}{C}{}_{{k}_{2}}^{} )} \qquad ( 27 )$$

Even though Equation (27) looks complicated, it is easier to compute as the outer sum of (B−1) terms can be controlled. Additionally, the inner sum as k₁ terms and k₁ is assumed to be small. In Equation (27), when K=2, the inner sum collapses into:

(^{b}Cₖ_{₁})

On the other hand, if k₂ is small, K will be counted from B to 2. When moving one band to the left, the second set of k₂ elements must have at least one element from the newly uncovered band. Again, this is done to ensure that sets are not over counted. For example, suppose the K-th band is being processed, then the total number of ways of choosing the first set of k₁ elements and the second set of k₂ elements, while ensuring that one or more elements in the second set are from band B−K, is:

$$( {}_{}^{( K - 1 ) \times b}{C}{}_{{k}_{1}}^{} ) {\sum }_{l = 1}^{{k}_{2}} ( {}_{}^{b}{C}{}_{l}^{} ) \times ( {}_{}^{( B - K ) xb}{C}{}_{{k}_{2} - l}^{} ) \qquad ( 28 )$$

The term outside the summation represents the number of ways a set of k₁ elements can be selected from the first K−1 bands. The summation represents the number of ways a set of k₂ elements can be selected from B−K+1 bands, where one or more elements of the set come from the K-th band (first term in the summation) and the rest from the B−K bands (second term in the summation). This ensures that all of the sets of k₂ elements selected are unique, which guarantees that all (k₁, k₂) pairs are unique.

Hence, the probability of selecting the first set and the second set such that all elements in the first set are less than or equal to the minimum element in the second set is:

$$\frac{{\sum }_{K = B}^{2} ( {}_{}^{( K - 1 ) \times b}{C}{}_{{k}_{1}}^{} ) {\sum }_{l = 1}^{{k}_{2}} ( {}_{}^{b}{C}{}_{l}^{} ) \times ( {}_{}^{( B - K ) xb}{C}{}_{{k}_{2} - l}^{} )}{( {}_{}^{N}{C}{}_{{k}_{1}}^{} ) \times ( {}_{}^{N}{C}{}_{{k}_{2}}^{} )} \qquad ( 29 )$$

Since the outer sum has B−1 terms, which can be controlled, and the inner sum as k₂ terms, which is assumed to be small, Equation (29) will be easier to compute than Equation (23). In Equation (29), when K=B, the inner sum collapses into:

(^{b}Cₖ_{₂})

In another implementation, calculating the probability of selecting a first set from a first domain and a second set from a second domain such that all elements in the first set are less than or equal to a minimum element in the second set comprises assuming there are no duplicate elements in either the first set or the second set, assuming the first domain intersects with the second domain, determining a number of distinct elements in the first domain, and determining a number of distinct elements in the second domain.

Based on the above assumptions and determinations, let N₁ be the number of distinct elements in the first domain, let N₂ be the number of distinct elements in the second domain, let N₁^{s} be the start of the first domain, let N₁^{e} be the end of the first domain, let N₂^{s} be the start of the second domain, let N₂^{e} be the end of the second domain, let k₁ be the number of elements to be selected for the first set, let k₂ be the number of elements to be selected for the second set, and let m be the minimum element in the second set.

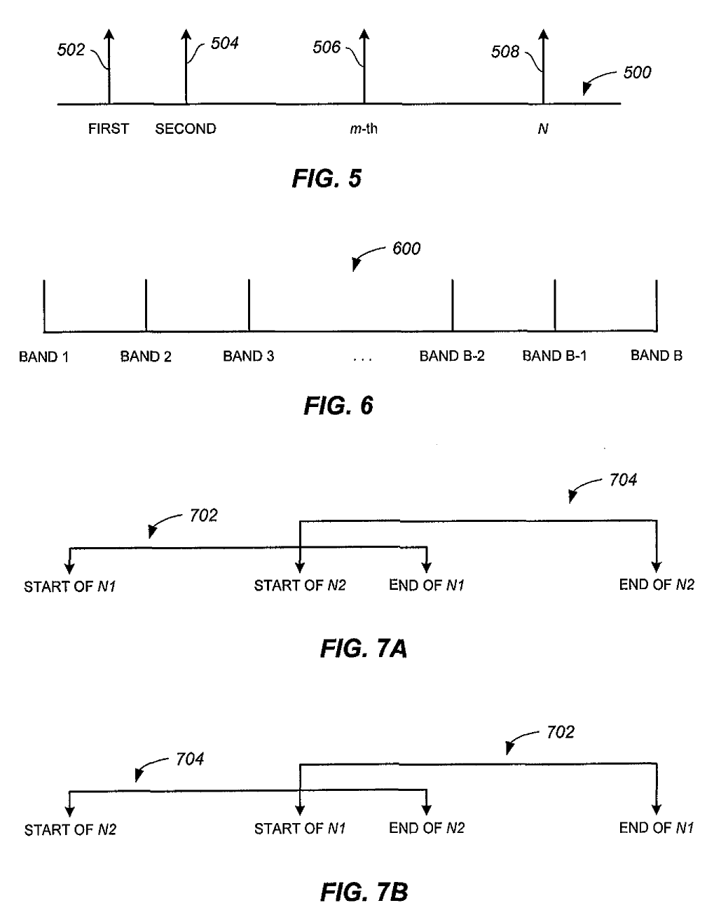

Depicted in FIGS. 7A-7B are sample number lines 702 and 704 representing domains according to an implementation of the invention. Number line 702 represents the N₁ distinct elements of the first domain and number line 704 represents the N₂ distinct elements of the second domain. Assume that the end (e.g., largest element) of the second domain is greater than the end (e.g., largest element) of the first domain, as depicted in FIG. 7A.

For counting purposes, the minimum element m of the second set can only range from N₂^{s} to N₁^{e} because when m moves beyond N₁^{e}, counting is no longer necessary as any set of k₁ elements selected from the range [N₁^{s}, N₁^{e}] will always be less than any set of k₂ elements selected from the range (N₁^{e}, N₂^{e}].

If the minimum element m of the second set lies in the range [N₂^{s}, N₁^{e}], then the total number of ways of choosing the first set and the second set such that all of the elements of the first set are less than or equal to the minimum element m of the second set is:

(^{N}^{₂}^{^{e}}^{-m}Cₖ_{₂}₋₁)×(^{m-N}^{₁}^{^{s}}⁺¹Cₖ_{₁}) (30)

The first term in Equation (30) represents the number of ways to select the second set of k₂ elements. Since the minimum for the second set is fixed at m, only k₂−1 elements need to be selected from the remaining range of N₂^{e}−m. In lieu of distribution information, standard uniformity assumption can be used to estimate the number of distinct elements in the N₂^{e}−m range. For purposes of simplicity, N₂^{e}−m also denotes the number of distinct elements in that range. The second term in Equation (30) represents the number of ways to select the first set of k₁ elements.

When m is in the range (N₁^{e}, N₂^{e}], then the total number of ways of selecting the first set of k₁ elements and the second set of k₂ elements is:

(^{N}^{₂}^{^{e}}^{-N}^{₁}^{^{e}}Cₖ_{₂})×(^{N}^{₁}Cₖ_{₁}) (31)

The first term in Equation (31) represents the number of ways a set of k₂ elements can be selected from the range (N₁^{e}, N₂^{e}]. The second term in Equation (31) represents the number of ways a set of k₁ elements can be selected from the first domain with N₁ distinct elements. Hence, the probability of selecting the first set and the second set such that all elements in the first set are less than or equal to the minimum element in the second set is:

$$\frac{[ {\sum }_{m = {N}_{2}^{s}}^{{N}_{1}^{e}} ( {}_{}^{{N}_{2}^{e} - m}{C}{}_{{k}_{2} - 1}^{} ) \times ( {}_{}^{m - {N}_{1}^{s} + 1}{C}{}_{{k}_{1}}^{} ) ] + ( {}_{}^{{N}_{2}^{e} - {N}_{1}^{e}}{C}{}_{{k}_{2}}^{} ) \times ( {}_{}^{{N}_{1}}{C}{}_{{k}_{1}}^{} )}{( {}_{}^{{N}_{1}}{C}{}_{{k}_{1}}^{} ) \times ( {}_{}^{{N}_{2}}{C}{}_{{k}_{2}}^{} )} \qquad ( 32 )$$

If it was assumed instead that the end of the first domain is greater than the end of the second domain, as depicted in FIG. 7B, then the probability of selecting the first set and the second set such that all elements in the first set are less than or equal to the minimum element in the second set would be:

$$\frac{[ {\sum }_{m = {N}_{1}^{s} + {k}_{1}}^{{N}_{2}^{e} - {k}_{2} + 1} ( {}_{}^{{N}_{2}^{e} - m}{C}{}_{{k}_{2} - 1}^{} ) \times ( {}_{}^{m - {N}_{1}^{s} + 1}{C}{}_{{k}_{1}}^{} ) ]}{( {}_{}^{{N}_{1}}{C}{}_{{k}_{1}}^{} ) \times ( {}_{}^{{N}_{2}}{C}{}_{{k}_{2}}^{} )} \qquad ( 33 )$$

Equation (33) assumes that the range given by the start of the first domain, which is now greater than the start of the second domain, and the end of the second domain, which is now less than the end of the first domain, is large enough to hold both the first set and the second set because otherwise the probability will be zero.

Probability that All Elements in Second Set ≦ Minimum Element in First Set

In one implementation, calculating the probability of selecting a first set from a first domain and a second set from a second domain such that all elements in the second set are less than or equal to a minimum element in the first set comprises assuming there are no duplicate elements in either the first set or the second set, assuming one of the first domain and the second domain is a superset of the other domain, and determining a number of distinct elements in the one domain that is a superset of the other domain.

Based on the above assumptions and determination, let N be the number of distinct elements in the one domain, let k₁ be the number of elements to be selected for the first set, let k₂ be the number of elements to be selected for the second set, and let m be the minimum element in the first set as well as the number of distinct elements in the one domain that are less than or equal to m. Using the same analysis that was used to arrive at Equation (23), the probability of selecting the first set and the second set such that all elements in the second set are less than or equal to the minimum element in the first set is:

$$\frac{{\sum }_{m = {k}_{2}}^{N - {k}_{1} + 1} ( {}_{}^{m}{C}{}_{{k}_{2}}^{} ) \times ( {}_{}^{N - m}{C}{}_{{k}_{1} - 1}^{} )}{( {}_{}^{N}{C}{}_{{k}_{1}}^{} ) \times ( {}_{}^{N}{C}{}_{{k}_{2}}^{} )} \qquad ( 34 )$$

The difference between Equation (34) and Equation (23) is in the numerator where the possible values of m now range from k₂ to N−k₁+1 because m now represent the minimum element in the first set, and where k₂ elements in the second set are now selected from m distinct elements and k₁−1 elements in the first set are selected from N−m distinct elements because all elements in the second set have to be less than or equal to the minimum element in the first set.

As discussed above with respect to Equation (23), Equation (34) may be computationally expensive. Therefore, following the analysis used to arrive at Equations (27) and (29), rather than compute the product in Equation (34) for every possible value of m, the one domain can be divided into B bands, where each band includes b elements. Assuming k₁ is small, the probability of selecting the first set and the second set such that all elements in the second set are less than or equal to the minimum element in the first set is:

$$\frac{{\sum }_{K = B}^{2} ( {}_{}^{( K - 1 ) \times b}{C}{}_{{k}_{2}}^{} ) {\sum }_{l = 1}^{{k}_{1}} ( {}_{}^{b}{C}{}_{l}^{} ) \times ( {}_{}^{( B - K ) xb}{C}{}_{{k}_{1} - l}^{} )}{( {}_{}^{N}{C}{}_{{k}_{1}}^{} ) \times ( {}_{}^{N}{C}{}_{{k}_{2}}^{} )} \qquad ( 35 )$$

Assuming k₂ is small, the probability of selecting the first set and the second set such that all elements in the second set are less than or equal to the minimum element in the first set is:

$$\frac{{\sum }_{K = 2}^{B} ( {}_{}^{( B - K + 1 ) \times b}{C}{}_{{k}_{1}}^{} ) {\sum }_{l = 1}^{{k}_{2}} ( {}_{}^{b}{C}{}_{l}^{} ) \times ( {}_{}^{( K - 2 ) xb}{C}{}_{{k}_{2} - l}^{} )}{( {}_{}^{N}{C}{}_{{k}_{1}}^{} ) \times ( {}_{}^{N}{C}{}_{{k}_{2}}^{} )} \qquad ( 36 )$$

In another implementation, calculating the probability of selecting a first set from a first domain and a second set from a second domain such that all elements in the second set are less than or equal to a minimum element in the first set comprises assuming there are no duplicate elements in either the first set or the second set, assuming the first domain intersects with the second domain, determining a number of distinct elements in the first domain, and determining a number of distinct elements in the second domain.

Based on the above assumptions and determinations, let N₁ be the number of distinct elements in the first domain, let N₂ be the number of distinct elements in the second domain, let N₁^{s} be the start of the first domain, let N₁^{e} be the end of the first domain, let N₂^{s} be the start of the second domain, let N₂^{e} be the end of the second domain, let k₁ be the number of elements to be selected for the first set, let k₂ be the number of elements to be selected for the second set, and let m be the minimum element in the second set.

Using the analysis used to arrive at Equations (32) and (33), if it is assumed that the end of the first domain is greater than the end of the second domain, then the probability of selecting the first set and the second set such that all elements in the second set are less than or equal to the minimum element in the first set is:

$$\frac{[ {\sum }_{m = {N}_{1}^{s}}^{{N}_{2}^{e}} ( {}_{}^{{N}_{1}^{e} - m}{C}{}_{{k}_{1} - 1}^{} ) \times ( {}_{}^{m - {N}_{2}^{s} + 1}{C}{}_{{k}_{2}}^{} ) ] + ( {}_{}^{{N}_{1}^{e} - {N}_{2}^{e}}{C}{}_{{k}_{1}}^{} ) \times ( {}_{}^{{N}_{2}}{C}{}_{{k}_{2}}^{} )}{( {}_{}^{{N}_{1}}{C}{}_{{k}_{1}}^{} ) \times ( {}_{}^{{N}_{2}}{C}{}_{{k}_{2}}^{} )} \qquad ( 37 )$$

If it is assumed instead that the end of the first domain is less than the end of the second domain, then the probability of selecting the first set and the second set such that all elements in the second set are less than or equal to the minimum element in the first set is:

$$\frac{[ {\sum }_{m = {N}_{2}^{s} + {k}_{2}}^{{N}_{1}^{e} - {k}_{1} + 1} ( {}_{}^{m - {N}_{2}^{s}}{C}{}_{{k}_{2}}^{} ) \times ( {}_{}^{{N}_{1}^{e} - m}{C}{}_{{k}_{2}}^{} ) ]}{( {}_{}^{{N}_{1}}{C}{}_{{k}_{1}}^{} ) \times ( {}_{}^{{N}_{2}}{C}{}_{{k}_{2}}^{} )} \qquad ( 38 )$$

Equation (38) assumes that the range given by the start of the second domain, which is now greater than the start of the first domain, and the end of the first domain, which is now less than the end of the second domain, is large enough to hold both the first set and the second set because otherwise the probability will be zero.

Probability that All Elements in First Set < Minimum Element in Second Set

In one implementation, calculating the probability of selecting a first set from a first domain and a second set from a second domain such that all elements in the first set are less than a minimum element in the second set comprises assuming there are no duplicate elements in either the first set or the second set, assuming one of the first domain and the second domain is a superset of the other domain, and determining a number of distinct elements in the one domain that is a superset of the other domain.

Based on the above assumptions and determination, let N be the number of distinct elements in the one domain, let k₁ be the number of elements to be selected for the first set, let k₂ be the number of elements to be selected for the second set, and let m be the minimum element in the second set as well as the number of distinct elements in the one domain that are less than or equal to m. Using the same analysis that was used to arrive at Equation (23), the probability of selecting the first set and the second set such that all elements in the first set are less than the minimum element in the second set is:

$$\frac{{\sum }_{m = {k}_{1} + 1}^{N - {k}_{2} + 1} ( {}_{}^{m - 1}{C}{}_{{k}_{1}}^{} ) \times ( {}_{}^{N - m}{C}{}_{{k}_{2} - 1}^{} )}{( {}_{}^{N}{C}{}_{{k}_{1}}^{} ) \times ( {}_{}^{N}{C}{}_{{k}_{2}}^{} )} \qquad ( 39 )$$

The difference between Equation (39) and Equation (23) is the first term in the numerator where the k₁ elements of the first set are selected from m−1 elements because the k₁ elements have to be strictly less than m, rather than less than or equal to m.

As discussed above with respect to Equation (23), Equation (39) may be computationally expensive. Therefore, following the analysis used to arrive at Equations (27) and (29), rather than compute the product in Equation (39) for every possible value of m, the one domain can be divided into B bands, where each band includes b elements. Assuming k₁ is small, the probability of selecting the first set and the second set such that all elements in the first set are less than the minimum element in the second set is:

$$\frac{{\sum }_{K = 2}^{B} ( {}_{}^{( B - K + 1 ) \times b}{C}{}_{{k}_{2}}^{} ) {\sum }_{l = 1}^{{k}_{1}} ( {}_{}^{b - 1}{C}{}_{l}^{} ) \times ( {}_{}^{( K - 2 ) \times b}{C}{}_{{k}_{1} - l}^{} )}{( {}_{}^{N}{C}{}_{{k}_{1}}^{} ) \times ( {}_{}^{N}{C}{}_{{k}_{2}}^{} )} \qquad ( 40 )$$

Assuming k₂ is small, the probability of selecting the first set and the second set such that all elements in the first set are less than the minimum element in the second set is:

$$\frac{{\sum }_{K = B}^{2} ( {}_{}^{( K - 1 ) \times b - 1}{C}{}_{{k}_{1}}^{} ) {\sum }_{l = 1}^{{k}_{2}} ( {}_{}^{b - 1}{C}{}_{l}^{} ) \times ( {}_{}^{( B - K ) \times b}{C}{}_{{k}_{2} - l}^{} )}{( {}_{}^{N}{C}{}_{{k}_{1}}^{} ) \times ( {}_{}^{N}{C}{}_{{k}_{2}}^{} )} \qquad ( 41 )$$

In another implementation, calculating the probability of selecting a first set from a first domain and a second set from a second domain such that all elements in the first set are less than a minimum element in the second set comprises assuming there are no duplicate elements in either the first set or the second set, assuming the first domain intersects with the second domain, determining a number of distinct elements in the first domain, and determining a number of distinct elements in the second domain.

Based on the above assumptions and determinations, let N₁ be the number of distinct elements in the first domain, let N₂ be the number of distinct elements in the second domain, let N₁^{s} be the start of the first domain, let N₁^{e} be the end of the first domain, let N₂^{s} be the start of the second domain, let N₂^{e} be the end of the second domain, let k₁ be the number of elements to be selected for the first set, let k₂ be the number of elements to be selected for the second set, and let m be the minimum element in the second set.

Using the analysis used to arrive at Equations (32) and (33), if it is assumed that the end of the second domain is greater than the end of the first domain, then the probability of selecting the first set and the second set such that all elements in the first set are less than the minimum element in the second set is:

$$\frac{\begin{matrix}[ {\sum }_{m = {N}_{1}^{s} + {k}_{1} + 1}^{{N}_{1}^{e}} ( {}_{}^{{N}_{2}^{e} - m}{C}{}_{{k}_{2} - 1}^{} ) \times ( {}_{}^{m - {N}_{1}^{s} - 1}{C}{}_{{k}_{1}}^{} ) ] + \\ ( {}_{}^{{N}_{2}^{e} - {N}_{1}^{e}}{C}{}_{{k}_{2}}^{} ) \times ( {}_{}^{{N}_{1}}{C}{}_{{k}_{1}}^{} )\end{matrix}}{( {}_{}^{{N}_{1}}{C}{}_{{k}_{1}}^{} ) \times ( {}_{}^{{N}_{2}}{C}{}_{{k}_{2}}^{} )} \qquad ( 42 )$$

If it is assumed instead that the end of the second domain is less than the end of the first domain, then the probability of selecting the first set and the second set such that all elements in the first set are less than the minimum element in the second set is:

$$\frac{[ {\sum }_{m = {N}_{1}^{s} + {k}_{1} + 1}^{{N}_{2}^{e} - {k}_{2} + 1} ( {}_{}^{{N}_{2}^{e} - m}{C}{}_{{k}_{2} - 1}^{} ) \times ( {}_{}^{m - {N}_{1}^{s} - 1}{C}{}_{{k}_{1}}^{} ) ]}{( {}_{}^{{N}_{1}}{C}{}_{{k}_{1}}^{} ) \times ( {}_{}^{{N}_{2}}{C}{}_{{k}_{2}}^{} )} \qquad ( 43 )$$

As with Equation (33), Equation (43) assumes that the range given by the start of the first domain, which is now greater than the start of the second domain, and the end of the second domain, which is now less than the end of the first domain, is large enough to hold both the first set and the second set because otherwise the probability will be zero.

Probability that All Elements in Second Set < Minimum Element in First Set

In one implementation, calculating the probability of selecting a first set from a first domain and a second set from a second domain such that all elements in the second set are less than a minimum element in the first set comprises assuming there are no duplicate elements in either the first set or the second set, assuming one of the first domain and the second domain is a superset of the other domain, and determining a number of distinct elements in the one domain that is a superset of the other domain.

Based on the above assumptions and determination, let N be the number of distinct elements in the one domain, let k₁ be the number of elements to be selected for the first set, let k₂ be the number of elements to be selected for the second set, and let m be the minimum element in the first set as well as the number of distinct elements in the one domain that are less than or equal to m. Using the same analysis that was used to arrive at Equation (23), the probability of selecting the first set and the second set such that all elements in the second set are less than the minimum element in the first set is:

$$\frac{{\sum }_{m = {k}_{2} + 1}^{N - {k}_{1} + 1} ( {}_{}^{m - 1}{C}{}_{{k}_{2}}^{} ) \times ( {}_{}^{N - m}{C}{}_{{k}_{1} - 1}^{} )}{( {}_{}^{N}{C}{}_{{k}_{1}}^{} ) \times ( {}_{}^{N}{C}{}_{{k}_{2}}^{} )} \qquad ( 44 )$$

As with Equation (39), the difference between Equation (44) and Equation (34) is the first term in the numerator where the k₂ elements of the first set are selected from m−1 elements because the k₂ elements have to be strictly less than m, rather than less than or equal to m.

As discussed above with respect to Equation (23), Equation (44) may be computationally expensive. Therefore, following the analysis used to arrive at Equations (27) and (29), rather than compute the product in Equation (44) for every possible value of m, the one domain can be divided into B bands, where each band includes b elements. Assuming k₁ is small, the probability of selecting the first set and the second set such that all elements in the second set are less than the minimum element in the first set is:

$$\frac{{\sum }_{K = B}^{2} ( {}_{}^{( K - 1 ) \times b - 1}{C}{}_{{k}_{2}}^{} ) {\sum }_{l = 1}^{{k}_{1}} ( {}_{}^{b}{C}{}_{l}^{} ) \times ( {}_{}^{( B - K ) \times b}{C}{}_{{k}_{1} - l}^{} )}{( {}_{}^{N}{C}{}_{{k}_{1}}^{} ) \times ( {}_{}^{N}{C}{}_{{k}_{2}}^{} )} \qquad ( 45 )$$

Assuming k₂ is small, the probability of selecting the first set and the second set such that all elements in the second set are less than the minimum element in the first set is:

$$\frac{{\sum }_{K = 2}^{B} ( {}_{}^{( B - K + 1 ) \times b}{C}{}_{{k}_{1}}^{} ) {\sum }_{l = 1}^{{k}_{2}} ( {}_{}^{b - 1}{C}{}_{l}^{} ) \times ( {}_{}^{( K - 2 ) \times b}{C}{}_{{k}_{2} - l}^{} )}{( {}_{}^{N}{C}{}_{{k}_{1}}^{} ) \times ( {}_{}^{N}{C}{}_{{k}_{2}}^{} )} \qquad ( 46 )$$

In another implementation, calculating the probability of selecting a first set from a first domain and a second set from a second domain such that all elements in the second set are less than a minimum element in the first set comprises assuming there are no duplicate elements in either the first set or the second set, assuming the first domain intersects with the second domain, determining a number of distinct elements in the first domain, and determining a number of distinct elements in the second domain.

Based on the above assumptions and determinations, let N₁ be the number of distinct elements in the first domain, let N₂ be the number of distinct elements in the second domain, let N₁^{s} be the start of the first domain, let N₁^{e} be the end of the first domain, let N₂^{s} be the start of the second domain, let N₂^{e} be the end of the second domain, let k₁ be the number of elements to be selected for the first set, let k₂ be the number of elements to be selected for the second set, and let m be the minimum element in the second set.

Using the analysis used to arrive at Equations (32) and (33), if it is assumed that the end of the first domain is greater than the end of the second domain, then the probability of selecting the first set and the second set such that all elements in the second set are less than the minimum element in the first set is:

$$\frac{\begin{matrix}[ {\sum }_{m = {N}_{2}^{s} + {k}_{2} + 1}^{{N}_{1}^{e} - {k}_{1} + 1} ( {}_{}^{{N}_{1}^{e} - m}{C}{}_{{k}_{1} - 1}^{} ) \times ( {}_{}^{m - {N}_{2}^{s} - 1}{C}{}_{{k}_{2}}^{} ) ] + \\ ( {}_{}^{{N}_{1}^{e} - {N}_{2}^{e}}{C}{}_{{k}_{1}}^{} ) \times ( {}_{}^{{N}_{2}}{C}{}_{{k}_{2}}^{} )\end{matrix}}{( {}_{}^{{N}_{1}}{C}{}_{{k}_{1}}^{} ) \times ( {}_{}^{{N}_{2}}{C}{}_{{k}_{2}}^{} )} \qquad ( 47 )$$

If it is assumed instead that the end of the first domain is less than the end of the second domain, then the probability of selecting the first set and the second set such that all elements in the second set are less than the minimum element in the first set is:

$$\frac{[ {\sum }_{m = {N}_{2}^{s} + {k}_{2} + 1}^{{N}_{1}^{e} - {k}_{1} + 1} ( {}_{}^{m - {N}_{2}^{s} - 1}{C}{}_{{k}_{2}}^{} ) \times ( {}_{}^{{N}_{1}^{e} - m}{C}{}_{{k}_{1} - 1}^{} ) ]}{( {}_{}^{{N}_{1}}{C}{}_{{k}_{1}}^{} ) \times ( {}_{}^{{N}_{2}}{C}{}_{{k}_{2}}^{} )} \qquad ( 48 )$$

As with Equation (38), Equation (48) assumes that the range given by the start of the second domain, which is now greater than the start of the first domain, and the end of the first domain, which is now less than the end of the second domain, is large enough to hold both the first set and the second set because otherwise the probability will be zero.

By taking into account the sequence sizes of sequences involved in XQuery join predicates and the comparison operator used between the sequences, calculating the complement probabilities, and dividing domain into a predetermined number of bands, selectivity estimation of XQuery join predicates is more economical. Additionally, there are no expensive upfront costs of having to collect and maintain complicated statistics of underlying data.

The invention can take the form of an entirely hardware implementation, an entirely software implementation, or an implementation containing both hardware and software elements. In one aspect, the invention is implemented in software, which includes, but is not limited to, application software, firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer-readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk, and an optical disk. Current examples of optical disks include DVD, compact disk-read-only memory (CD-ROM), and compact disk-read/write (CD-R/W).

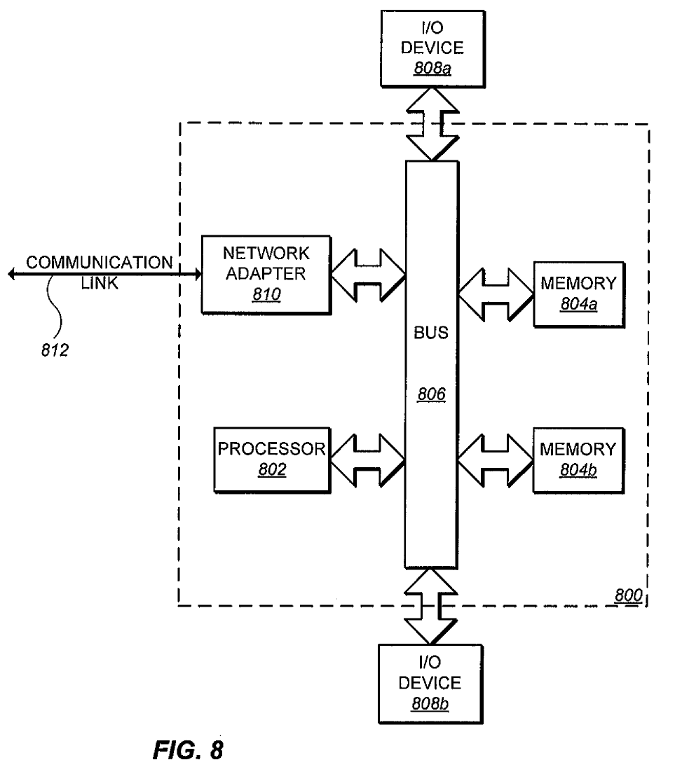

FIG. 8 shows a data processing system 800 suitable for storing and/or executing program code. Data processing system 800 includes a processor 802 coupled to memory elements 804a-b through a system bus 806. In other implementations, data processing system 800 may include more than one processor and each processor may be coupled directly or indirectly to one or more memory elements through a system bus.

Memory elements 804a-b can include local memory employed during actual execution of the program code, bulk storage, and cache memories that provide temporary storage of at least some program code in order to reduce the number of times the code must be retrieved from bulk storage during execution. As shown, input/output or I/O devices 808a-b (including, but not limited to, keyboards, displays, pointing devices, etc.) are coupled to data processing system 800. I/O devices 808a-b may be coupled to data processing system 800 directly or indirectly through intervening I/O controllers (not shown).

In the implementation, a network adapter 810 is coupled to data processing system 800 to enable data processing system 800 to become coupled to other data processing systems or remote printers or storage devices through communication link 812. Communication link 812 can be a private or public network. Modems, cable modems, and Ethernet cards are just a few of the currently available types of network adapters.

While various implementations estimating selectivity of XQuery join predicates have been described, the technical scope of the present invention is not limited thereto. For example, the present invention is described in terms of particular systems having certain components and particular methods having certain steps in a certain order. One of ordinary skill in the art, however, will readily recognize that the methods described herein can, for instance, include additional steps and/or be in a different order, and that the systems described herein can, for instance, include additional or substitute components. Hence, various modifications or improvements can be added to the above implementations and those modifications or improvements fall within the technical scope of the present invention.

What is claimed is:

1. A method for estimating a selectivity of a join predicate in an XQuery expression, the method comprising:
determining a first sequence size of a first sequence in the join predicate of the XQuery expression, the first sequence size corresponding to a number of elements included in the first sequence;
determining a second sequence size of a second sequence in the join predicate of the XQuery expression, the second sequence size corresponding to a number of elements included in the second sequence;
determining a type of comparison operator used between the first sequence and the second sequence in the join predicate of the XQuery expression;
estimating the selectivity of the join predicate in the XQuery expression based on the first sequence size, the second sequence size, and the type of comparison operator used between the first sequence and the second sequence,
wherein responsive to the type of comparison operator being an equal to operator, the selectivity of the join predicate is estimated by
calculating a probability of selecting a first set of one or more elements from a first domain and a second set of one or more elements from a second domain such that the first set and the second set do not intersect,
wherein a number of elements to be selected for the first set is equal to the first sequence size and a number of elements to be selected for the second set is equal to the second sequence size,
wherein the first set and the second set do not intersect when none of the elements in the first set is found in the second set and none of the elements in the second set is found in the first set, and
subtracting from 1 the probability of selecting the first set and the second set such that the first set and the second set do not intersect;
selecting an execution plan for the XQuery expression based on the selectivity of the join predicate; and
executing the XQuery expression using the execution plan.

2. The method of claim 1, wherein calculating the probability of selecting the first set and the second set such that the first set and the second set do not intersect comprises:
assuming there are no duplicate elements in either the first set or the second set,
assuming one of the first domain and the second domain is a superset of the other domain,
determining a number of distinct elements in the one domain that is a superset of the other domain, and
calculating the probability of selecting the first set and the second set such that the first set and the second set do not intersect using the equation:
$$\frac{( {}_{}^{N - {k}_{1}}{C}{}_{{k}_{2}}^{} )}{( {}_{}^{N}{C}{}_{{k}_{2}}^{} )}$$
where N is the number of distinct elements in the one domain, k₁ is the number of elements to be selected for the first set, and k₂ is the number of elements to be selected for the second set.

3. The method of claim 1, wherein calculating the probability of selecting the first set and the second set such that the first set and the second set do not intersect comprises:
assuming one of the first domain and the second domain is a superset of the other domain,
determining a number of distinct elements in the one domain that is a superset of the other domain, and
calculating the probability of selecting the first set and the second set such that the first set and the second set do not intersect using the equations:
$$\frac{{\sum }_{{m}_{1} = 1}^{{k}_{1}} ( {}_{}^{N}{C}{}_{{m}_{1}}^{} ) \times ( {}_{}^{{k}_{1} - 1}{C}{}_{{k}_{1} - {m}_{1}}^{} ) \times ( {}_{}^{N - {m}_{1} + {k}_{2} - 1}{C}{}_{{k}_{2}}^{} )}{( {}_{}^{N + {k}_{1} - 1}{C}{}_{{k}_{1}}^{} ) \times ( {}_{}^{N + {k}_{2} - 1}{C}{}_{{k}_{2}}^{} )} if {k}_{1} is small or$$
$$\frac{{\sum }_{{m}_{2} = 1}^{{k}_{2}} ( {}_{}^{N}{C}{}_{{m}_{2}}^{} ) \times ( {}_{}^{{k}_{2} - 1}{C}{}_{{k}_{2} - {m}_{2}}^{} ) \times ( {}_{}^{N - {m}_{2} + {k}_{1} - 1}{C}{}_{k 1}^{} )}{( {}_{}^{N + {k}_{1} - 1}{C}{}_{{k}_{1}}^{} ) \times ( {}_{}^{N + {k}_{2} - 1}{C}{}_{{k}_{2}}^{} )} if {k}_{2} is small$$
where N is the number of distinct elements in the one domain, k₁ is the number of elements to be selected for the first set, k₂ is the number of elements to be selected for the second set, m₁ is the number of distinct elements from which elements in first set are selected, and m₂ is the number of distinct elements from which elements in the second set are selected.

4. The method of claim 1, wherein calculating the probability of selecting the first set and the second set such that the first set and the second set do not intersect comprises:
assuming there are no duplicate elements in either the first set or the second set,
assuming the first domain intersects with the second domain,
determining a number of distinct elements in the first domain,
determining a number of distinct elements in the second domain,
calculating the probability of selecting the first set and the second set such that the first set and the second set do not intersect using the equation:
$$\frac{{\sum }_{m = 0}^{{k}_{1}} ( {}_{}^{{N}_{1} / {N}_{2}}{C}{}_{m}^{} ) \times ( {}_{}^{{N}_{1} {N}_{2}}{C}{}_{{k}_{1} - m}^{} ) \times ( {}_{}^{{N}_{2} - ( {k}_{1} - m )}{C}{}_{{k}_{2}}^{} )}{( {}_{}^{{N}_{1}}{C}{}_{{k}_{1}}^{} ) \times ( {}_{}^{{N}_{2}}{C}{}_{{k}_{2}}^{} )}$$
where N₁ is the number of distinct elements in the first domain, N₂ is the number of distinct elements in the second domain, N₁/N₂ is a number of distinct elements in the first domain that are not in the intersection of the first domain and the second domain, N₁N₂ is a number of distinct elements in the intersection of the first domain and the second domain, k₁ is the number of elements to be selected for the first set, k₂ is the number of elements to be selected for the second set, and m is a number of elements to be selected for the first set from N₁/N₂.

5. The method of claim 1,
wherein responsive to the type of operator being a greater than operator, the selectivity of the join predicate is estimated by
calculating a probability of selecting a first set of one or more elements from a first domain and a second set of one or more elements from a second domain such that all elements in the first set are less than or equal to a minimum element in the second set,
wherein a number of elements to be selected for the first set is equal to the first sequence size and a number of elements to be selected for the second set is equal to the second sequence size, and
subtracting from 1 the probability of selecting the first set and the second set such that all elements in the first set are less than or equal to the minimum element in the second set;
wherein responsive to the type of operator being a less than operator, the selectivity of the join predicate is estimated by
calculating a probability of selecting a first set of one or more elements from a first domain and a second set of one or more elements from a second domain such that all elements in the second set are less than or equal to a minimum element in the first set,
wherein a number of elements to be selected for the first set is equal to the first sequence size and a number of elements to be selected for the second set is equal to the second sequence size, and
subtracting from 1 the probability of selecting the first set and the second set such that all elements in the second set are less than or equal to the minimum element in the first set;
wherein responsive to the type of operator being a greater than or equal to operator, the selectivity of the join predicate is estimated by
calculating a probability of selecting a first set of one or more elements from a first domain and a second set of one or more elements from a second domain such that all elements in the first set are less than a minimum element in the second set,
wherein a number of elements to be selected for the first set is equal to the first sequence size and a number of elements to be selected for the second set is equal to the second sequence size, and
subtracting from 1 the probability of selecting the first set and the second set such that all elements in the first set are less than the minimum element in the second set; and
wherein responsive to the type of operator being a less than or equal to operator, the selectivity of the join predicate is estimated by
calculating a probability of selecting a first set of one or more elements from a first domain and a second set of one or more elements from a second domain such that all elements in the second set are less than a minimum element in the first set,
wherein a number of elements to be selected for the first set is equal to the first sequence size and a number of elements to be selected for the second set is equal to the second sequence size, and
subtracting from 1 the probability of selecting the first set and the second set such that all elements in the second set are less than the minimum element in the first set.

6. The method of claim 5,
wherein calculating the probability of selecting the first set and the second set such that all elements in the first set are less than or equal to the minimum element in the second set comprises:
assuming there are no duplicate elements in either the first set or the second set,
assuming one of the first domain and the second domain is a superset of the other domain,
determining a number of distinct elements in the one domain that is a superset of the other domain, and
calculating the probability of selecting the first set and the second set such that all elements in the first set are less than or equal to the minimum element in the second set using the equation:
$$\frac{{\sum }_{m = {k}_{1}}^{N - {k}_{2} + 1} ( {}_{}^{m}{C}{}_{{k}_{1}}^{} ) \times ( {}_{}^{N - m}{C}{}_{{k}_{2} - 1}^{} )}{( {}_{}^{N}{C}{}_{{k}_{1}}^{} ) \times ( {}_{}^{N}{C}{}_{{k}_{2}}^{} )}$$
where N is the number of distinct elements in the one domain, k₁ is the number of elements to be selected for the first set, k₂ is the number of elements to be selected for the second set, and m is the minimum element in the second set as well as the number of distinct elements in the one domain that are less than or equal to m;
wherein calculating the probability of selecting the first set and the second set such that all elements in the second set are less than or equal to the minimum element in the first set comprises:
assuming there are no duplicate elements in either the first set or the second set,
assuming one of the first domain and the second domain is a superset of the other domain,
determining a number of distinct elements in the one domain that is a superset of the other domain, and
calculating the probability of selecting the first set and the second set such that all elements in the second set are less than or equal to the minimum element in the first set using the equation:
$$\frac{{\sum }_{m = {k}_{2}}^{N - {k}_{1} + 1} ( {}_{}^{m}{C}{}_{{k}_{2}}^{} ) \times ( {}_{}^{N - m}{C}{}_{{k}_{1} - 1}^{} )}{( {}_{}^{N}{C}{}_{{k}_{1}}^{} ) \times ( {}_{}^{N}{C}{}_{{k}_{2}}^{} )}$$
where N is the number of distinct elements in the one domain, k₁ is the number of elements to be selected for the first set, k₂ is the number of elements to be selected for the second set, and m is the minimum element in the first set as well as the number of distinct elements in the one domain that are less than or equal to m;
wherein calculating the probability of selecting the first set and the second set such that all elements in the first set are less than the minimum element in the second set comprises:
assuming there are no duplicate elements in either the first set or the second set,
assuming one of the first domain and the second domain is a superset of the other domain,
determining a number of distinct elements in the one domain that is a superset of the other domain, and
calculating the probability of selecting the first set and the second set such that all elements in the first set are less than the minimum element in the second set using the equation:
$$\frac{{\sum }_{m = {k}_{1} + 1}^{N - {k}_{2} + 1} ( {}_{}^{m - 1}{C}{}_{{k}_{1}}^{} ) \times ( {}_{}^{N - m}{C}{}_{{k}_{2} - 1}^{} )}{( {}_{}^{N}{C}{}_{{k}_{1}}^{} ) \times ( {}_{}^{N}{C}{}_{{k}_{2}}^{} )}$$
where N is the number of distinct elements in the one domain, k₁ is the number of elements to be selected for the first set, k₂ is the number of elements to be selected for the second set, and m is the minimum element in the second set as well as the number of distinct elements in the one domain that are less than or equal to m; and
wherein calculating the probability of selecting the first set and the second set such that all elements in the second set are less than the minimum element in the first set comprises:
assuming there are no duplicate elements in either the first set or the second set,
assuming one of the first domain and the second domain is a superset of the other domain,
determining a number of distinct elements in the one domain that is a superset of the other domain, and
calculating the probability of selecting the first set and the second set such that all elements in the second set are less than the minimum element in the first set using the equation:
$$\frac{{\sum }_{m = {k}_{2} + 1}^{N - {k}_{1} + 1} ( {}_{}^{m - 1}{C}{}_{{k}_{2}}^{} ) \times ( {}_{}^{N - m}{C}{}_{{k}_{1} - 1}^{} )}{( {}_{}^{N}{C}{}_{{k}_{1}}^{} ) \times ( {}_{}^{N}{C}{}_{{k}_{2}}^{} )}$$
where N is the number of distinct elements in the one domain, k₁ is the number of elements to be selected for the first set, k₂ is the number of elements to be selected for the second set, and m is the minimum element in the first set as well as the number of distinct elements in the one domain that are less than or equal to m.

7. The method of claim 5,
wherein calculating the probability of selecting the first set and the second set such that all elements in the first set are less than or equal to the minimum element in the second set comprises:
assuming there are no duplicate elements in either the first set or the second set,
assuming one of the first domain and the second domain is a superset of the other domain,
determining a number of distinct elements in the one domain that is a superset of the other domain,
dividing the one domain into a predetermined number of bands, wherein each band comprises a predetermined number of elements, and
calculating the probability of selecting the first set and the second set such that all elements in the first set are less than or equal to the minimum element in the second set using the equation:
$$\frac{{\sum }_{K = 2}^{B} ( {}_{}^{( B - K + 1 ) \times b}{C}{}_{{k}_{2}}^{} ) {\sum }_{l = 1}^{{k}_{1}} ( {}_{}^{b}{C}{}_{l}^{} ) \times {(}^{( K - 2 ) \times b} {C}_{{k}_{1} - l} )}{( {}_{}^{N}{C}{}_{{k}_{1}}^{} ) \times ( {}_{}^{N}{C}{}_{{k}_{2}}^{} )} if {k}_{1} is small or$$
$$\frac{{\sum }_{K = B}^{2} ( {}_{}^{( K - 1 ) \times b}{C}{}_{{k}_{1}}^{} ) {\sum }_{l = 1}^{{k}_{2}} ( {}_{}^{b}{C}{}_{l}^{} ) \times ( {}_{}^{( B - k ) \times b}{C}{}_{{k}_{2} - l}^{} )}{( {}_{}^{N}{C}{}_{{k}_{1}}^{} ) \times ( {}_{}^{N}{C}{}_{{k}_{2}}^{} )} if {k}_{2} is small$$
where N is the number of distinct elements in the one domain, k₁ is the number of elements to be selected for the first set, k₂ is the number of elements to be selected for the second set, B is the predetermined number of bands in which the one domain is divided into, and b is the predetermined number of elements in each band;
wherein calculating the probability of selecting the first set and the second set such that all elements in the second set are less than or equal to the minimum element in the first set comprises:
assuming there are no duplicate elements in either the first set or the second set,
assuming one of the first domain and the second domain is a superset of the other domain,
determining a number of distinct elements in the one domain that is a superset of the other domain,
dividing the one domain into a predetermined number of bands, wherein each band comprises a predetermined number of elements, and
calculating the probability of selecting the first set and the second set such that all elements in the second set are less than or equal to the minimum element in the first set using the equation:
$$\frac{{\sum }_{K = B}^{2} ( {}_{}^{( K - 1 ) \times b}{C}{}_{{k}_{2}}^{} ) {\sum }_{l = 1}^{{k}_{1}} ( {}_{}^{b}{C}{}_{l}^{} ) \times {(}^{( B - k ) \times b} {C}_{{k}_{1} - l} )}{( {}_{}^{N}{C}{}_{{k}_{1}}^{} ) \times ( {}_{}^{N}{C}{}_{{k}_{2}}^{} )} if {k}_{1} is small or$$
$$\frac{{\sum }_{K = 2}^{B} ( {}_{}^{( K - 1 ) \times b}{C}{}_{{k}_{2}}^{} ) {\sum }_{l = 1}^{{k}_{1}} ( {}_{}^{b}{C}{}_{l}^{} ) \times ( {}_{}^{( K - 2 ) \times b}{C}{}_{{k}_{2} - l}^{} )}{( {}_{}^{N}{C}{}_{{k}_{1}}^{} ) \times ( {}_{}^{N}{C}{}_{{k}_{2}}^{} )} if {k}_{2} is small$$
where N is the number of distinct elements in the one domain, k₁ is the number of elements to be selected for the first set, k₂ is the number of elements to be selected for the second set, B is the predetermined number of bands in which the one domain is divided into, and b is the predetermined number of elements in each band;
wherein calculating the probability of selecting the first set and the second set such that all elements in the first set are less than the minimum element in the second set comprises:
assuming there are no duplicate elements in either the first set or the second set,
assuming one of the first domain and the second domain is a superset of the other domain,
determining a number of distinct elements in the one domain that is a superset of the other domain,
dividing the one domain into a predetermined number of bands, wherein each band comprises a predetermined number of elements, and
calculating the probability of selecting the first set and the second set such that all elements in the first set are less than the minimum element in the second set using the equation:
$$\frac{{\sum }_{K = 2}^{B} ( {}_{}^{( B - K + 1 ) \times b}{C}{}_{{k}_{2}}^{} ) {\sum }_{l = 1}^{{k}_{1}} ( {}_{}^{b - 1}{C}{}_{l}^{} ) \times {(}^{( K - 2 ) \times b} {C}_{{k}_{1} - l} )}{( {}_{}^{N}{C}{}_{{k}_{1}}^{} ) \times ( {}_{}^{N}{C}{}_{{k}_{2}}^{} )} if {k}_{1} is small or$$
$$\frac{{\sum }_{K = B}^{2} ( {}_{}^{( K - 1 ) \times b - 1}{C}{}_{{k}_{1}}^{} ) {\sum }_{l = 1}^{{k}_{2}} ( {}_{}^{b - 1}{C}{}_{l}^{} ) \times ( {}_{}^{( B - K ) \times b}{C}{}_{{k}_{2} - l}^{} )}{( {}_{}^{N}{C}{}_{{k}_{1}}^{} ) \times ( {}_{}^{N}{C}{}_{{k}_{2}}^{} )} if {k}_{2} is small$$
where N is the number of distinct elements in the one domain, k₁ is the number of elements to be selected for the first set, k₂ is the number of elements to be selected for the second set, B is the predetermined number of bands in which the one domain is divided into, and b is the predetermined number of elements in each band; and
wherein calculating the probability of selecting the first set and the second set such that all elements in the second set are less than the minimum element in the first set comprises:
assuming there are no duplicate elements in either the first set or the second set,
assuming one of the first domain and the second domain is a superset of the other domain,
determining a number of distinct elements in the one domain that is a superset of the other domain,
dividing the one domain into a predetermined number of bands, wherein each band comprises a predetermined number of elements, and
calculating the probability of selecting the first set and the second set such that all elements in the second set are less than the minimum element in the first set using the equation:
$$\frac{{\sum }_{K = B}^{2} ( {}_{}^{( K - 1 ) \times b - 1}{C}{}_{{k}_{2}}^{} ) {\sum }_{l = 1}^{{k}_{1}} ( {}_{}^{b}{C}{}_{l}^{} ) \times {(}^{( B - K ) \times b} {C}_{{k}_{1} - l} )}{( {}_{}^{N}{C}{}_{{k}_{1}}^{} ) \times ( {}_{}^{N}{C}{}_{{k}_{2}}^{} )} if {k}_{1} is small or$$
$$\frac{{\sum }_{K = 2}^{B} ( {}_{}^{( B - K + 1 ) \times b}{C}{}_{{k}_{1}}^{} ) {\sum }_{l = 1}^{{k}_{2}} ( {}_{}^{b - 1}{C}{}_{l}^{} ) \times ( {}_{}^{( K - 2 ) \times b}{C}{}_{{k}_{2} - l}^{} )}{( {}_{}^{N}{C}{}_{{k}_{1}}^{} ) \times ( {}_{}^{N}{C}{}_{{k}_{2}}^{} )} if {k}_{2} is small$$
where N is the number of distinct elements in the one domain, k₁ is the number of elements to be selected for the first set, k₂ is the number of elements to be selected for the second set, B is the predetermined number of bands in which the one domain is divided into, and b is the predetermined number of elements in each band.

8. The method of claim 5,
wherein calculating the probability of selecting the first set and the second set such that all elements in the first set are less than or equal to the minimum element in the second set comprises:
assuming there are no duplicate elements in either the first set or the second set,
assuming the first domain intersects with the second domain,
determining a number of distinct elements in the first domain,
determining a number of distinct elements in the second domain,
calculating the probability of selecting the first set and the second set such that all elements in the first set are less than or equal to the minimum element in the second set using the equation:
$$\frac{[ {\sum }_{m = {N}_{2}^{s}}^{{N}_{1}^{e}} ( {}_{}^{{N}_{2}^{e} - m}{C}{}_{{k}_{2} - 1}^{} ) \times ( {}_{}^{m - {N}_{1}^{s} + 1}{C}{}_{{k}_{1}}^{} ) ] + ( {}_{}^{{N}_{2}^{e} - {N}_{1}^{e}}{C}{}_{{k}_{2}}^{} ) \times ( {}_{}^{{N}_{1}}{C}{}_{{k}_{1}}^{} )}{( {}_{}^{{N}_{1}}{C}{}_{{k}_{1}}^{} ) \times ( {}_{}^{{N}_{2}}{C}{}_{{k}_{2}}^{} )}$$
if end of the second domain is greater than end of the first domain
$$\frac{[ {\sum }_{m = {N}_{1}^{s} + {k}_{1}}^{{N}_{2}^{e} - {k}_{2} + 1} ( {}_{}^{{N}_{2}^{e} - m}{C}{}_{{k}_{2} - 1}^{} ) \times ( {}_{}^{m - {N}_{1}^{s} + 1}{C}{}_{{k}_{1}}^{} ) ]}{( {}_{}^{{N}_{1}}{C}{}_{{k}_{1}}^{} ) \times ( {}_{}^{{N}_{2}}{C}{}_{{k}_{2}}^{} )}$$
if end of the second domain is less than end of the first domain
where N₁ is the number of distinct elements in the first domain, N₂ is the number of distinct elements in the second domain, N₁^{s} is the start of the first domain, N₁^{e} is the end of the first domain, N₂^{s} is the start of the second domain, N₂^{e} is the end of the second domain, k₁ is the number of elements to be selected for the first set, k₂ is the number of elements to be selected for the second set, and m is the minimum element in the second set;
wherein calculating the probability of selecting the first set and the second set such that all elements in the second set are less than or equal to the minimum element in the first set comprises:
assuming there are no duplicate elements in either the first set or the second set,
assuming the first domain intersects with the second domain,
determining a number of distinct elements in the first domain,
determining a number of distinct elements in the second domain,
calculating the probability of selecting the first set and the second set such that all elements in the second set are less than or equal to the minimum element in the first set using the equation:
$$\frac{[ {\sum }_{m = {N}_{1}^{s}}^{{N}_{2}^{e}} ( {}_{}^{{N}_{1}^{e} - m}{C}{}_{{k}_{1} - 1}^{} ) \times ( {}_{}^{m - {N}_{2}^{s} + 1}{C}{}_{{k}_{2}}^{} ) ] + ( {}_{}^{{N}_{1}^{e} - {N}_{2}^{e}}{C}{}_{{k}_{1}}^{} ) \times ( {}_{}^{{N}_{2}}{C}{}_{{k}_{2}}^{} )}{( {}_{}^{{N}_{1}}{C}{}_{{k}_{1}}^{} ) \times ( {}_{}^{{N}_{2}}{C}{}_{{k}_{2}}^{} )}$$
if end of the first domain is greater than end of the second domain
$$\frac{[ {\sum }_{m = {N}_{2}^{s} + {k}_{2}}^{{N}_{1}^{e} - {k}_{1} + 1} ( {}_{}^{m - {N}_{2}^{s}}{C}{}_{{k}_{2}}^{} ) \times ( {}_{}^{{N}_{1}^{e} - m}{C}{}_{{k}_{2}}^{} ) ]}{( {}_{}^{{N}_{1}}{C}{}_{{k}_{1}}^{} ) \times ( {}_{}^{{N}_{2}}{C}{}_{{k}_{2}}^{} )}$$
if end of the first domain is less than end of the second domain
where N₁ is the number of distinct elements in the first domain, N₂ is the number of distinct elements in the second domain, N₁^{s} is the start of the first domain, N₁^{e} is the end of the first domain, N₂^{s} is the start of the second domain, N₂^{e} is the end of the second domain, k₁ is the number of elements to be selected for the first set, k₂ is the number of elements to be selected for the second set, and m is the minimum element in the first set;
wherein calculating the probability of selecting the first set and the second set such that all elements in the first set are less than the minimum element in the second set comprises:
assuming there are no duplicate elements in either the first set or the second set,
assuming the first domain intersects with the second domain,
determining a number of distinct elements in the first domain,
determining a number of distinct elements in the second domain,
calculating the probability of selecting the first set and the second set such that all elements in the first set are less than the minimum element in the second set using the equation:
$$\frac{[ {\sum }_{m = {N}_{1}^{s} + {k}_{1} + 1}^{{N}_{1}^{e}} ( {}_{}^{{N}_{2}^{e} - m}{C}{}_{{k}_{2} - 1}^{} ) \times ( {}_{}^{m - {N}_{1}^{s} - 1}{C}{}_{{k}_{1}}^{} ) ] + ( {}_{}^{{N}_{2}^{e} - {N}_{1}^{e}}{C}{}_{{k}_{2}}^{} ) \times ( {}_{}^{{N}_{1}}{C}{}_{{k}_{1}}^{} )}{( {}_{}^{{N}_{1}}{C}{}_{{k}_{1}}^{} ) \times ( {}_{}^{{N}_{2}}{C}{}_{{k}_{2}}^{} )}$$
if end of the second domain is greater than end of the first domain
$$\frac{[ {\sum }_{m = {N}_{1}^{s} + {k}_{1} + 1}^{{N}_{2}^{e} - {k}_{2} + 1} ( {}_{}^{{N}_{2}^{e} - m}{C}{}_{{k}_{2} - 1}^{} ) \times ( {}_{}^{m - {N}_{1}^{s} - 1}{C}{}_{{k}_{1}}^{} ) ]}{( {}_{}^{{N}_{1}}{C}{}_{{k}_{1}}^{} ) \times ( {}_{}^{{N}_{2}}{C}{}_{{k}_{2}}^{} )}$$
if end of the second domain is less than end of the first domain
where N₁ is the number of distinct elements in the first domain, N₂ is the number of distinct elements in the second domain, N₁^{s} is the start of the first domain, N₁^{e} is the end of the first domain, N₂^{s} is the start of the second domain, N₂^{e} is the end of the second domain, k₁ is the number of elements to be selected for the first set, k₂ is the number of elements to be selected for the second set, and m is the minimum element in the second set; and
wherein calculating the probability of selecting the first set and the second set such that all elements in the second set are less than the minimum element in the first set comprises:
assuming there are no duplicate elements in either the first set or the second set,
assuming the first domain intersects with the second domain,
determining a number of distinct elements in the first domain,
determining a number of distinct elements in the second domain,
calculating the probability of selecting the first set and the second set such that all elements in the second set are less than the minimum element in the first set using the equation:
$$\frac{[ {\sum }_{m = {N}_{1}^{s} + {k}_{2} + 1}^{{N}_{1}^{e} - {k}_{1} + 1} ( {}_{}^{{N}_{1}^{e} - m}{C}{}_{{k}_{1} - 1}^{} ) \times ( {}_{}^{m - {N}_{2}^{s} - 1}{C}{}_{{k}_{2}}^{} ) ] + ( {}_{}^{{N}_{1}^{e} - {N}_{2}^{e}}{C}{}_{{k}_{1}}^{} ) \times ( {}_{}^{{N}_{2}}{C}{}_{{k}_{2}}^{} )}{( {}_{}^{{N}_{1}}{C}{}_{{k}_{1}}^{} ) \times ( {}_{}^{{N}_{2}}{C}{}_{{k}_{2}}^{} )}$$
if end of the first domain is greater than end of the second domain
$$\frac{[ {\sum }_{m = {N}_{2}^{s} + {k}_{2} + 1}^{{N}_{1}^{e} - {k}_{1} + 1} ( {}_{}^{m - {N}_{2}^{s} - 1}{C}{}_{{k}_{2}}^{} ) \times ( {}_{}^{{N}_{1}^{e} - m}{C}{}_{{k}_{1} - 1}^{} ) ]}{( {}_{}^{{N}_{1}}{C}{}_{{k}_{1}}^{} ) \times ( {}_{}^{{N}_{2}}{C}{}_{{k}_{2}}^{} )}$$
if end of the first domain is less than end of the second domain
where N₁ is the number of distinct elements in the first domain, N₂ is the number of distinct elements in the second domain, N₁^{s} is the start of the first domain, N₁^{e} is the end of the first domain, N₂^{s} is the start of the second domain, N₂^{e} is the end of the second domain, k₁ is the number of elements to be selected for the first set, k₂ is the number of elements to be selected for the second set, and m is the minimum element in the first set.
